(19) United States
(12) Patent Application Publication
(10) Pub. No.: US 2007/0264167 A1
(43) Pub. Date: Nov. 15, 2007

(54) Receptacle for receiving a thin-walled flexible cup and article organizers

(75) Inventor: Charles Y. Warner, Orem, UT (US)

Correspondence Address: EVERETT D. ROBINSON;Echelon IP, LLC, P.O. Box 1047, American Fork, UT, 84003-1047, US

(73) Assignee: XK Development, LLC

(21) Appl. No.: 11/433,239

(22) Filed: May 12, 2006

(51) Int. Cl. B01L 9/00

(52) U.S. Cl. 422/104

(57) ABSTRACT

Inventions described herein relate generally to receptacles for securing articles in cups such as disposable cups, and more particularly to receptacles that provide for entry of a flexible cup by way of a channel narrower than the width of a cup incorporated into a shoulder for retaining a cup rim or wall and an interface that mates with the rim of such a cup providing containment of articles inside. Receptacles may include a seat for a seal against the cup rim. Detailed information on various example embodiments of the inventions are provided in the Detailed Description below, and the inventions are defined by the appended claims.

### SUMMARY

Inventions described herein relate generally to receptacles for securing articles in cups such as disposable cups, and more particularly to receptacles that provide for entry of a flexible cup by way of a channel narrower than the width of a cup incorporated into a shoulder for retaining a cup rim or wall and an interface that mates with the rim of such a cup providing containment of articles inside. Receptacles may include a seat for a seal against the cup rim. Detailed information on various example embodiments of the inventions are provided in the Detailed Description below, and the inventions are defined by the appended claims.

### BACKGROUND

No matter what one's occupation or hobby, it is often the case that one will have need to store small articles for retrieval at a later time. Countless variations of storage solutions have appeared on the shelves of retailers, utilizing drawers, lids, subdividing walls or inserts, bags, boxes, bins and a host of other concepts. Many of these solutions are designed to be durable, and the components of those solutions savable and sometimes cleanable should that be necessary.

For many, a cleaning step is rarely performed because the articles being stored are not likely to be dirty or to leave residues on the storage product. Others work with dirty articles that may be frequently rotated. A good example of such a one is an auto mechanic. As an engine or other automotive component is disassembled, parts that have been exposed to dust, grease, oil and other contaminants are removed and are needed to be stored for later reassembly. These parts are often not interchangeable, and parts of different sizes, lengths and forms need to be kept track of for the mechanic to know where they should be placed in reassembly. The systems of keeping track of parts vary from person to person, and might be simply placing removed components near the locations of reassembly, a parts tray in reliance on memory, or a more elaborate system of labeled containers identifying the parts and locations of reassembly.

Some containers that have been or might be used include paper envelopes, plastic bags, containers with dividers, small boxes, and even disposable drinking cups. Articles might be identified by a writing or label on the container, or alternately by writing on an article or tape wrapped around or attached to the article. Many containers are susceptible to being knocked over or off a table, or getting lost or tossed out in the trash. An open container might spill out its contents at least causing a difficulty for the storer but sometimes also resulting in lost parts or articles and damage thereto.

The disposable cup offers certain advantages as a storage container. Most are relatively inexpensive, and can be purchased for pennies each. Many are stackable, and thus may be efficiently stored in bulk. Most can be written on with a felt-tip marker, and thus are suitable for labeling of their contents. They are available in different sizes, and thus can accommodate articles of a number of shapes and sizes.

Even so, the disposable cup seems to have two properties which prevent its wide adoption as a generic storage container. First, most regularly use cups as temporary storage for beverages or small foods such as candy. In that use, a cup may be set on a countertop, table or windowsill and are easily bumped, knocked over or thrown away. Thus most do not see the disposable cup as a secure container for long-term storage. Second, there are generally not products for holding disposable cups as storage containers for other than beverages, rather the most common holding products take the form of cup dispensers, auto cup holders or cardboard or fiberboard containers which a cup might be inserted down into. Existing cup holders leave closure of the cup to separately provided lids, and do not serve to secure the contents against spillage or falling debris.

### DESCRIPTION OF THE DRAWINGS

FIG. 1 depicts a first exemplary receptacle with a disposable cup secured therein.

FIGS. 2A and 2B depict the first exemplary receptacle looking upward and from the front, respectively.

FIG. 3 shows the shapes of three layers that form the first exemplary receptacle.

FIGS. 4A, 4B and 4C depict the insertion of a disposable cup into the first exemplary receptacle as viewed from underneath.

FIGS. 5A and 5B show in section the relationship of the first exemplary receptacle to a secured cup.

FIGS. 6A, 6B and 6C depict an exemplary half receptacle moldable in plastic.

FIGS. 7A and 7B depict a row of half receptacles mounted to a frame.

FIG. 7C depicts an array of half receptacles composed of several framed rows.

FIGS. 8A and 8B depict another exemplary half receptacle with angled sides.

FIG. 8C shows an array of exemplary half receptacles secured to a lazy-susan frame.

FIGS. 9A, 9B, 9C, 9D and 9E depict a half receptacle fashioned from sheet metal.

FIG. 10 depicts a seal and a half receptacle adapted to receive it.

FIG. 11 illustrates a laminated seal structure.

FIG. 12 depicts a cup mounted to a half receptacle that incorporates a seal.

FIG. 13 depicts the half receptacle of FIG. 10 as viewed from above.

FIG. 14 depicts the half receptacle of FIG. 10 as viewed from the front.

FIG. 15 shows the relationship of a disposable cup secured into the half receptacle of FIG. 10.

FIG. 16 shows a half receptacle formed in two positionally variable parts.

FIG. 17 depicts a half receptacle formed of sheet metal having enterable from two directions.

Reference will now be made in detail to some embodiments of the inventions, example of which are illustrated in the accompanying drawings.

### DESCRIPTION

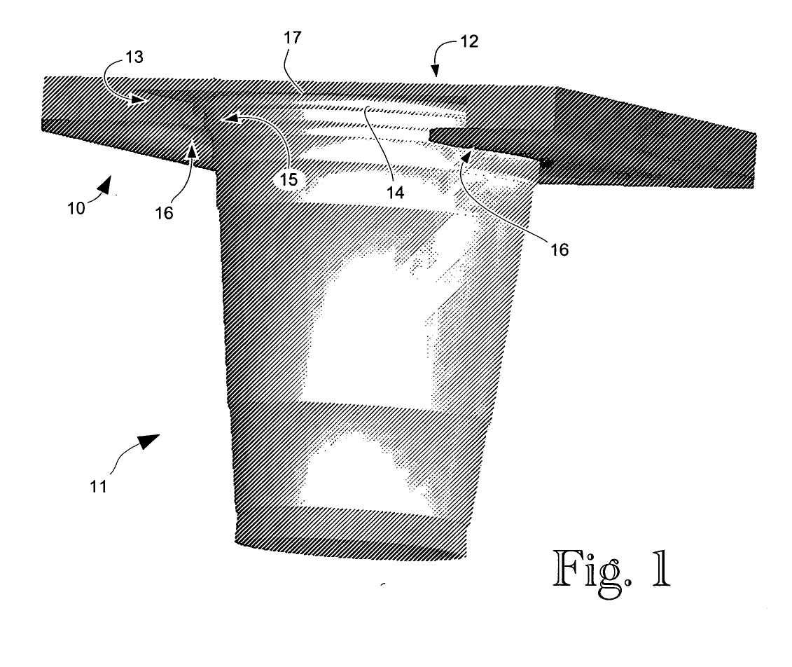

Receptacles disclosed herein functionally operate to secure a thin-walled, flexible cup and to provide a closure for the cup interior thereby containing any contents within the cup. Referring to FIG. 1, a first exemplary receptacle 10 is shown with cup 11 in a secured position. Exemplary receptacle includes a substrate 12, which in this example forms a basis for other receptacle components. In this example, substrate 12 includes a flat interface 17 mating with the top of cup 11 thereby creating a closure. A channel 13 provides a space for locating cup rim 14, and in this example for the upper wall 15 of cup 11. A shoulder 16 is located below the cup rim 14 or upper wall 15, substantially encircling the cup sufficiently to impede an exit of the cup out of the receptacle generally as described below. The area of contact of the shoulder on the cup either in a secured position or in any position of insertion of withdrawal is referred to herein as the area of shoulder engagement. The shoulder maintains an opening smaller than rim 14 or upper wall 15, and thereby prevents substantial separation of cup rim 14 from interface 17.

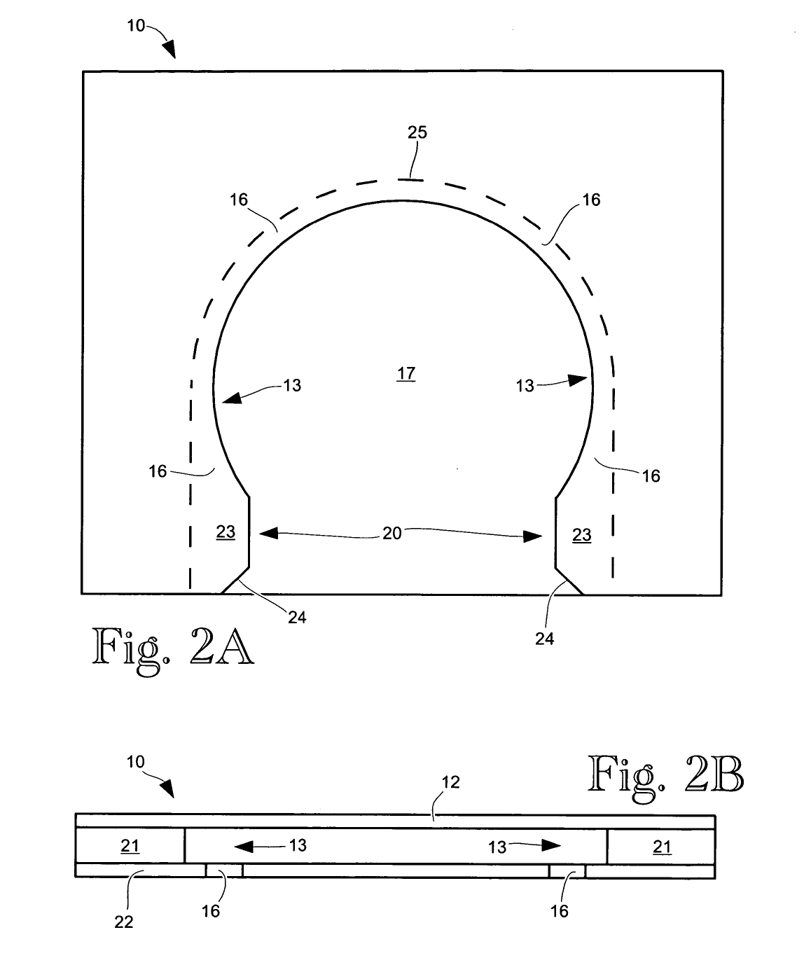

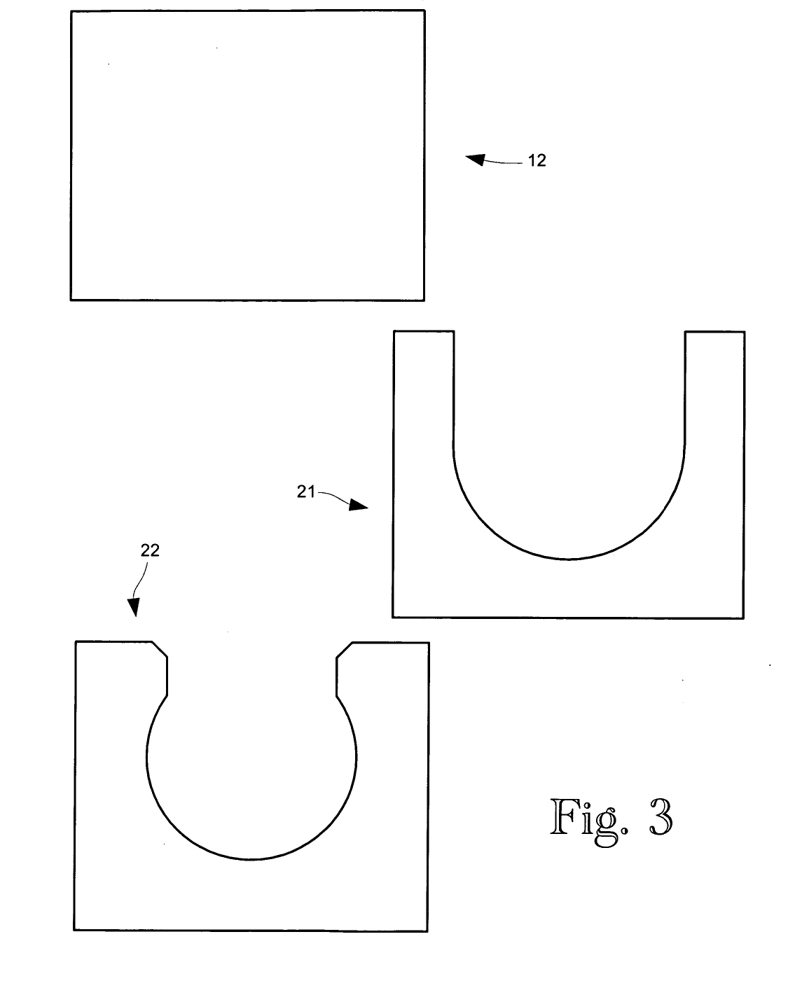

Other components of the first exemplary receptacle 10 are better visible from the bottom and front sides, illustrated in FIGS. 2A and 2B (hereinafter FIG. 2) respectively. First referring to FIG. 2B, exemplary receptacle 10 is fashioned in three layers, which are the substrate 12, an intermediate channel layer 21 and a lower shoulder layer 22, stacked as shown. The shapes of each of these layered components is provided in FIG. 3.

Referring back to FIG. 2A and looking up through the lower shoulder layer 22 to the substrate 12, channel 13 formed in intermediate channel layer 21 is shaped to permit the rim and/or upper part of the cup to pass through channel 13 substantially unobstructed to the rear wall 25. In this example rear wall 25, and the portion of shoulder 16 nearby, function as a stop to insertion motion of the cup. In this example, rear wall 25 is fashioned in the same shape as the cup rim, although other shapes may be used equally well as will be seen in examples described below. Restriction shoulder portions 23 are positioned at a width 20 smaller than that of the cup at the point of contact, preventing exiting of the cup in its normal shape.

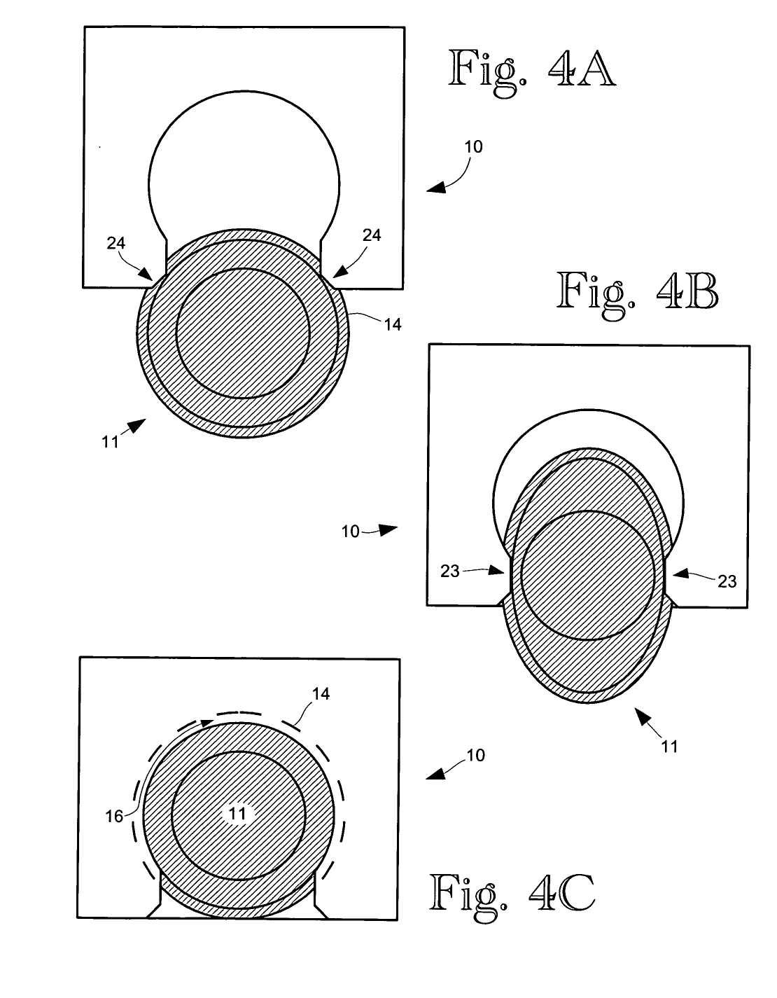

Illustrating the insertion and securement of a cup in the exemplary receptacle, direct your attention now to the three positions of FIGS. 4A, 4B and 4C. A substrate and receptacle 10 might, in most cases, be provided substantially horizontally to avoid spillage of a cup's contents, but other orientations may be used in accordance with the desired application. Utilizing an orientation with a horizontal substrate, in these figures the receptacle is viewed from below, looking at the bottom of a cup being inserted. First referring to FIG. 4A, a cup 11 is shown beginning to be inserted into receptacle 10. Cup rim 14 is positioned at the opening of channel 13, and may be contacting substrate 12 or interface 17. In the exemplary receptacle 10 the restriction shoulder portions 23 are tapered or rounded 24 to assist the free movement of a cup 11 as it is inserted, although that is not a necessary feature. At this position, cup 11 cannot be inserted without deformation from its normal shape.

To insert the cup 11 into the receptacle 10, the cup may be squeezed from the sides. For an ordinary drinking cup, squeezing of the cup sides results in the rim taking an elliptical shape, while the bottom of the cup may remain relatively undisturbed. From the position shown in FIG. 4A, a squeezed cup 11 will narrow and may be passed through the restriction shoulder portions 23, as shown in FIG. 4B. Further insertion force moves cup 11 further into the receptacle 10, and any elasticity in the cup will tend to force cup 11 into the secured position shown in FIG. 4C. In that position, the rim of cup 11 is positioned substantially between the substrate and the lower shoulder layer, restricting the movement of the cup downward (out of the page). Transverse securement of the cup is achieved through the shoulder portion 16, while the narrowed separation between portions 23 restricts movement out of the receptacle of a relaxed (unsqueezed) cup. The combination of restriction shoulder portions 23 and channel 13 sufficiently wide to receive the upper portion of the cup in effect forms a detent feature that holds the cup in a retained position. Removal of the cup is achieved by again squeezing the sides of the cup and pulling the cup out of the receptacle.

The receptacles disclosed herein may accommodate many different types of cups, provided those cups are non-destructively flexible. Many disposable plastic drinking cups are well-suited for use with the receptacles. The first exemplary receptacle, for example, accommodates a 16 oz. polyethylene disposable cup available from the Solo Cup Company of Highland Park, Ill. Cups of that type have good elasticity, and may be temporarily deformed from 4 to under 3 inches wide (75%) at the rim without cracking or losing the original shape. Thus the width 20 between portions 23 in the first exemplary receptacle is about 2⅞ inches. Width 20 may be increased if desired, creating a receptacle that is easier to insert a cup into, but at the expense of a more solid feel or potentially some rocking of the cup on the shoulder. Likewise, a smaller width 20 can be used providing a more solid hold and feel of a cup in the receptacle, but makes insertion and extraction more difficult due to the increased squeezing pressure needed and potential cup breakage.

Other plastic compositions may also be selected if it is desired, for example to give the user a solid feel or to make the receptacle usable by those with weaker hands. Cups of less-flexible materials such as polystyrene or paper might be used as well, if a receptacle utilizes a large width 20 that does not require a deformation beyond the breaking properties of the particular material. Likewise, a cup from virtually any elastomer or other material with elastic properties while maintaining manual squeezability can be used, if a width 20 is selected appropriately. A receptacle for a cup made from a particularly elastic material, such as latex rubber, might utilize an even smaller width 20. Although it is possible to use a cup made from a squeezable non-elastic material, such as a semi-rigid cloth or metal mesh, users may find cups that spontaneously return to their original shapes easier to use.

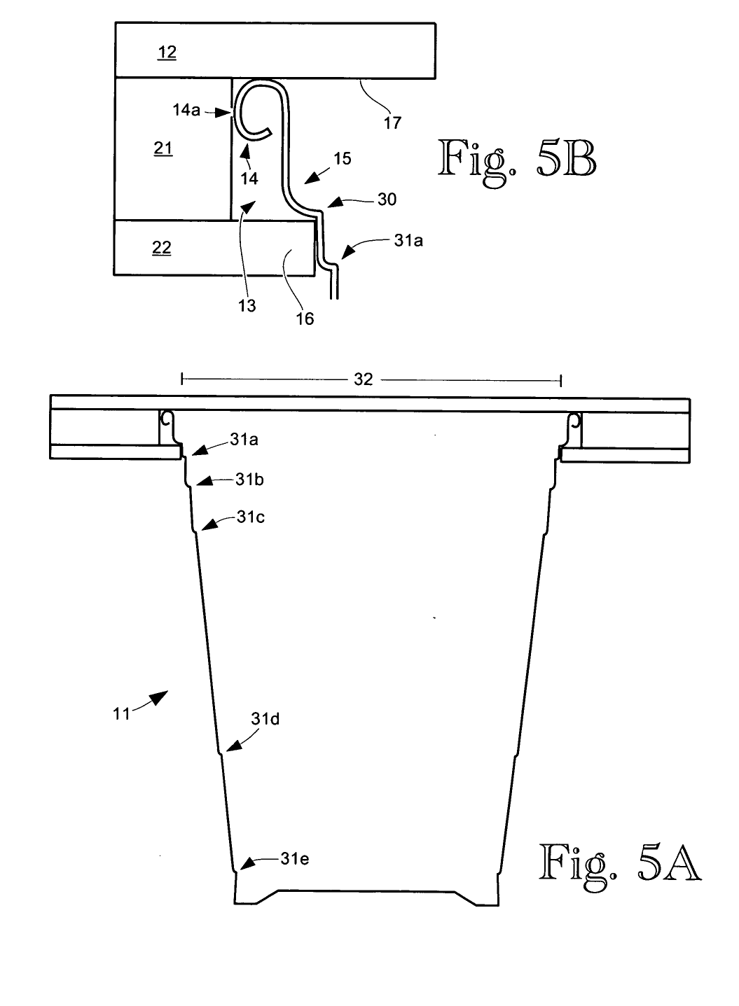

To further understand the fit of cup 11 in the first receptacle, refer now to FIG. 5A showing a cut-away view of the first exemplary receptacle about the center of a secured plastic cup. Its companion drawing, FIG. 5B, shows a close-up of the region of restraint around the rim 14 of cup 11. The profile of this particular cup incorporates steps 30 and 31a-e, which may have been provided for aesthetic reasons, or a functional reason such as to prevent over-insertion of stacked cups. Regardless, a step incorporated into the cup profile may provide an engagement to a receptacle shoulder, in this example 16. Step 30 provides a natural rest for the cup to shoulder 16, which shoulder is positioned relative to interface 17 to generally match the distance between the step 30 and the top of rim 14. Note that that distance, in the first exemplary receptacle, is controlled by the thickness of intermediate layer 21. That distance may be varied somewhat. A slightly larger distance may reduce the force necessary for cup insertion while providing a looser fit. A smaller distance may provide a better seal between the rim 14 and interface 17, but may require some deformation of the cup sidewall. Also in this example, the shoulder to shoulder distance 32 is selected to match the profile of cup 11 at the point(s) of contact below step 30, which restrains the transverse motion of the cup in the receptacle.

In the cup shown in FIGS. 5A and 5B, several other steps 31a-e are incorporated into cup 11. These steps may also be used to engage a shoulder of a receptacle if desired. Note, however that utilizing a step near the rim of the cup may provide increased restraint from rocking of the cup in the receptacle and generally a better fit and/or seal between the rim of the cup and its interface in the receptacle.

Also in the upper wall area 15 of the profile of cup 11 of FIG. 5B, a taper is formed widening the cup as the profile is traversed from the bottom toward the rim. The tapered area of upper wall 15 forces the cup toward the interface 17, should the cup be misaligned with respect to the shoulder 16. The position of a shoulder may be positioned to contact a taper in the cup, and thereby improve the fit of the cup in the receptacle. Alternatively, a cup need not include steps as shown. Rather, a cup may be tapered to expand wider at the mouth, and a receptacle could engage at a location on such a taper.

In another alternative, channel 13 might be fashioned to accommodate the rim of a cup. As shown in FIG. 5B, a cup rim is made to have a rounded edge, and includes an out-curved portion 14a. A shoulder might be made to contact the outward-protruding portion of a cup rim, and thereby restraining the cup substantially at the mouth and not necessarily through a portion of the cup sidewall. As cup 11 is a disposable drinking cup, it is desirable to have a smooth rim 14 comfortable to the lips of a drinker. Other cups might be utilized with an annular hard rim, which might be left untrimmed or in a rough condition—particularly if a receptacle shoulder provides sufficient transverse restraint against the cup side. Thus although in the first exemplary receptacle channel 13 fits somewhat tightly to the rim of cup 11, channel 13 could also be made wider relying on the transverse support provided by shoulder 16 at distance 32.

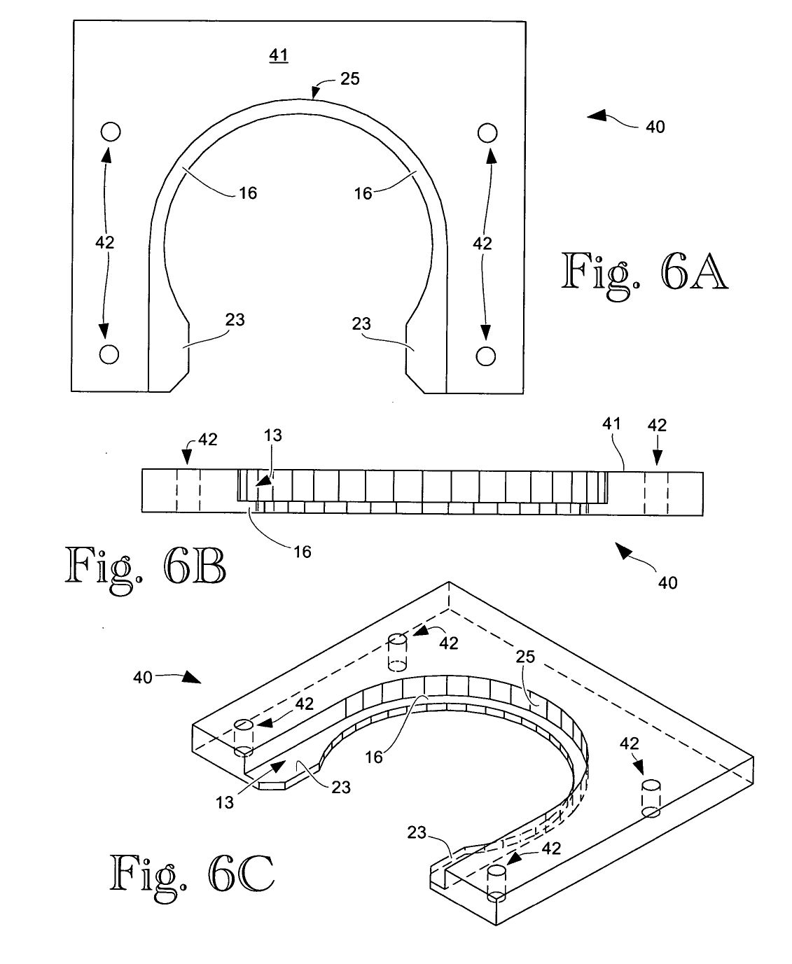

The first exemplary receptacle is designed to be constructed in three layers. A receptacle portion can also be formed as a part, attachable to a flat substrate such as a board, plate or metal, plastic or plywood piece. For this purpose, a substrate need not be completely flat, rather it might include concave portions inside the rim of a mounted cup, or intruding or protruding portions outside the a cup mating area as desired. A non-flat substrate could also be used provided that a tight fit between a cup rim and the substrate is not needed according to the tolerances of use. In FIGS. 6A, 6B and 6C a half receptacle 40 is shown. Half 40 includes an interface 41 capable of mating to a flat surface, in this example. Half 40 further includes holes 42 for securing the half to a flat substrate, using a selected fastener. For the example shown, those fasteners might be screws, nuts and bolts, rivets or even plastic snap rivets for easy assembly by a consumer. Now although in the example holes for fasteners are provided, virtually any other attachment may equally be used equally well, for example nails, self-cutting screws or fasteners built into the receptacle half such as tabs, glues, or chemical or integral welding.

Comparing receptacle half to the first exemplary receptacle of FIG. 2, the reader will note that half 40 incorporates a similar shoulder 16, restriction shoulder portions 23, rear wall 25 and a channel 13 completed by the mating of half 40 to a substrate. Referring back to FIG. 1, flat interface 17 may be formed in the substrate to which half 40 is attached, thereby restricting cup motion in the vertical (off the shoulder) direction.

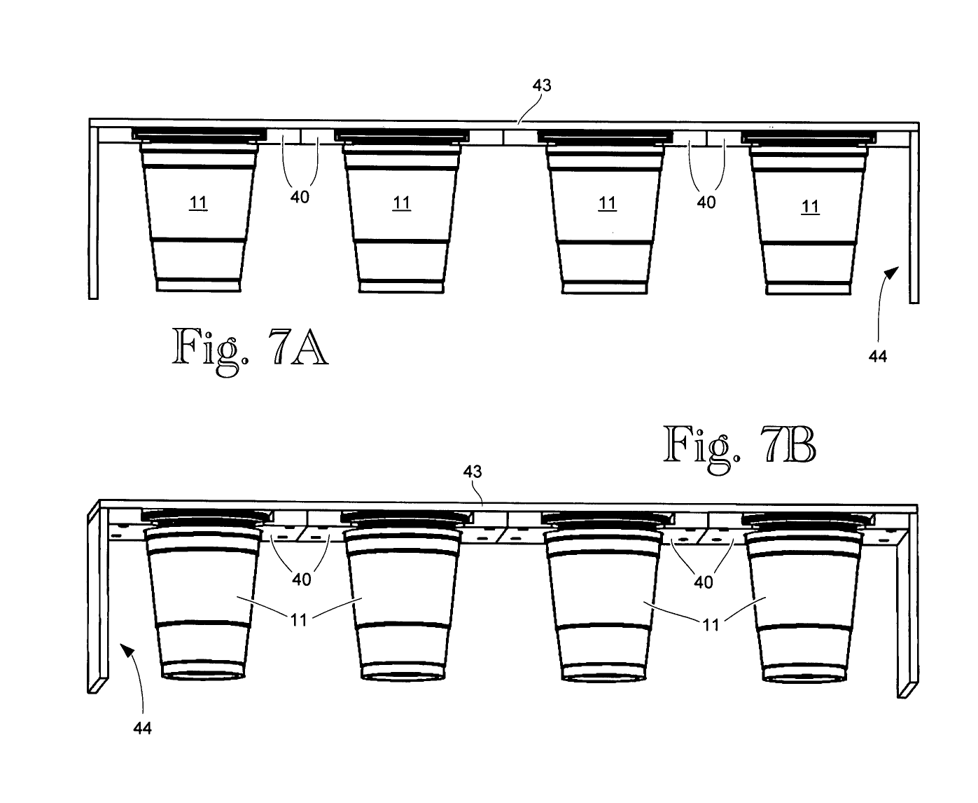

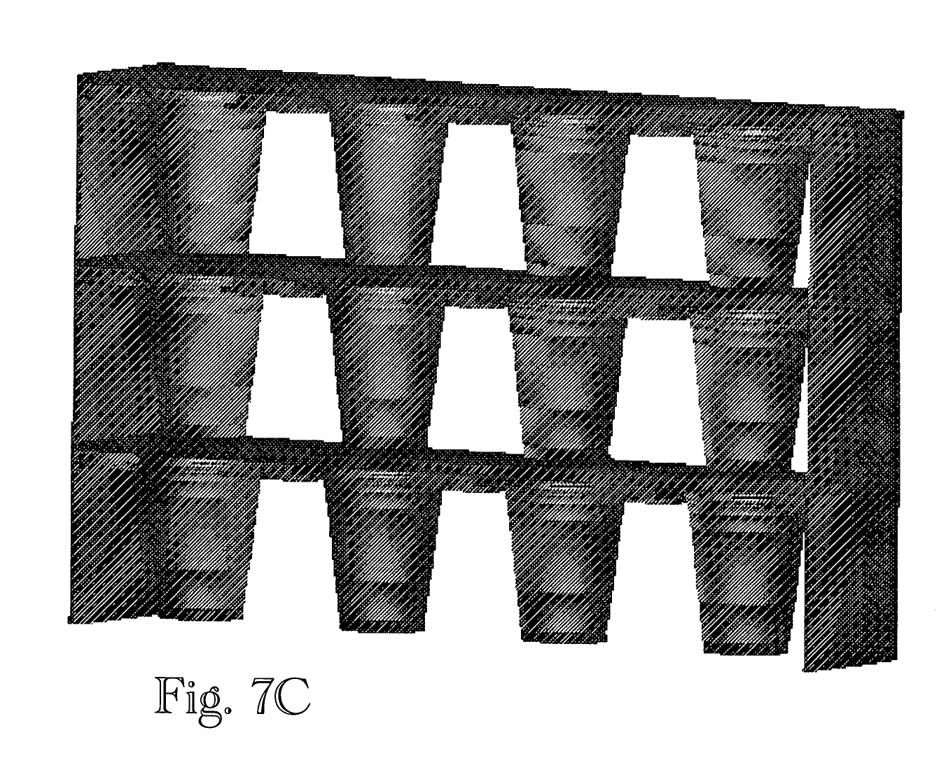

Although the half receptacle 40 could be fashioned by machining or another method, the half receptacle 40 might be advantageously manufactured in plastic using injection molding in perhaps a two-part mold substantially as shown, perhaps with slight tapers to holes 42 and to other vertical surfaces such as wall 25. Shown now in FIG. 7A, from the front, and FIG. 7B, in perspective, is an array of half receptacles 40 attached to a frame 44 that includes a substrate 43 to which half receptacles 40 are attached, with cups 11 mounted therein. From the front, any of cups 11 can be independently accessed, inserted or withdrawn. In this example, frame 44 forms a building unit from which larger arrays can be fashioned, such as that shown in FIG. 7C. A frame and receptacle array could also be constructed from other than half receptacles, for example using a layered construction as in the first exemplary receptacle. Now the arrangements shown are merely exemplary, and half receptacles could be mounted, or any cup receptacle herein disclosed fashioned in any convenient or desirable arrangement.

For example, a person might want to provide cup storage near a workbench surrounded by cupboards or shelves. That person might attach half-receptacles to the underside of on overhang of the workbench or shelf, or to the underside of a cabinet with perhaps an additional filler board or block. That person might also build his own frame to accommodate the number of cups needed in his desired configuration.

A half receptacle, as shown or otherwise, could be packaged or sold as a unit, perhaps with any necessary fasteners or attachments and instructions for mounting and use. Alternatively, a number of half-receptacles could be packaged as a storage solution kit. Additionally, a storage solution kit might include a frame with receptacles formed therein or half-receptacles attached or attachable thereto. The frame might be provided in any state of assembly, from completed to uncompleted as desired. Receptacles included in such a kit or frame need not be all of the same size, rather receptacles of different sizes may be included that provide for a selected variety of sizes, volumes, diameters or any other metric of cups with in a kit, frame or upgrade.

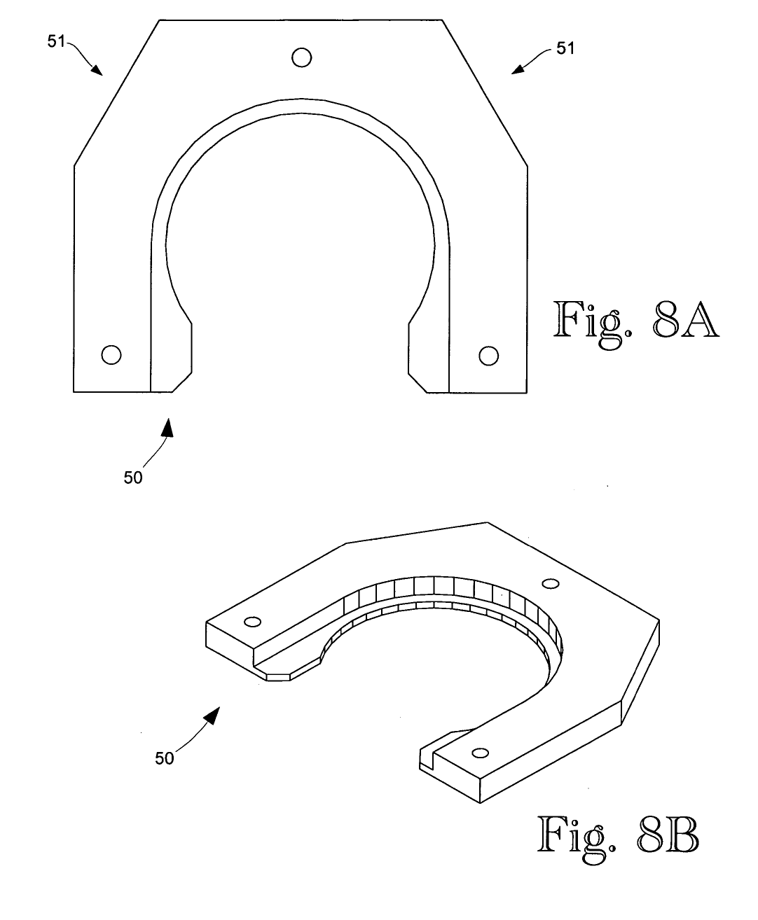

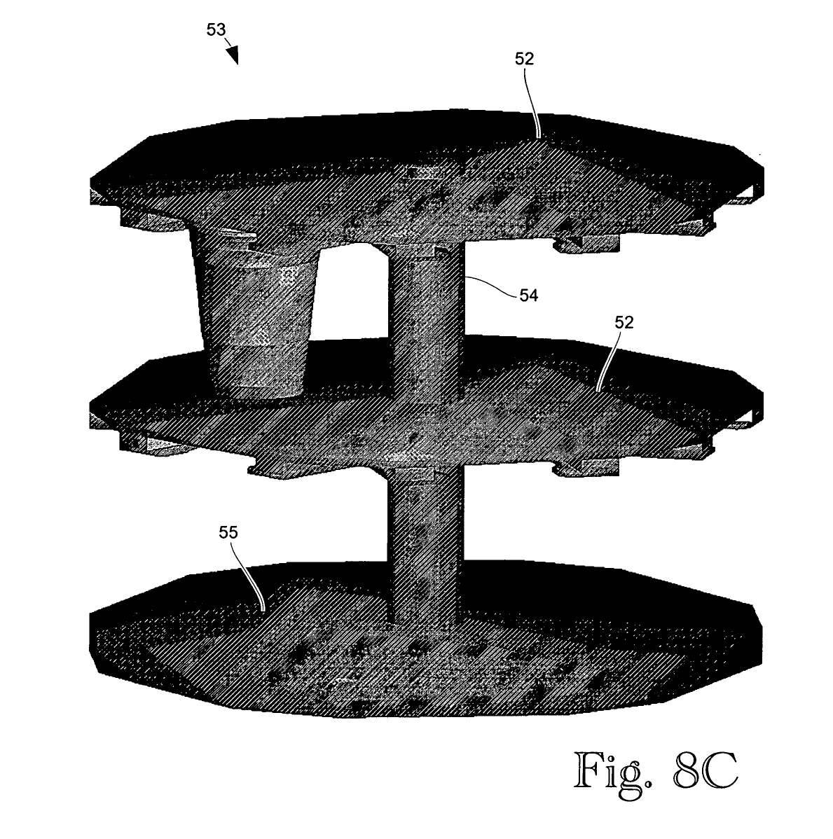

Referring now to FIGS. 8A and 8B, a half receptacle may be varied to suit an intended arrangement, environment or accommodation. Exemplary half receptacle 50 includes angular sides 51 angled to each other at about sixty degrees. A series of these half receptacles may be placed adjacently using sides 51, thereby forming a closely fitting circular array. Turning now to FIG. 8C, when mounted to a hexagonally or circularly shaped substrate 52, a circular array 53 is formed, which may be mounted on a pole 54 and base 55 as shown, in one example. If desired, circular arrays 53 might turn independently of each other, or might be fixed in position relative to pole 54 wherein the assembly is rotatable either with respect to the base 55 or the object on which it sits. Rather than sixty degrees, other angles might be chosen, and the sides, shape or form of a half receptacle or receptacle may be made to conform to any arrangement desired.

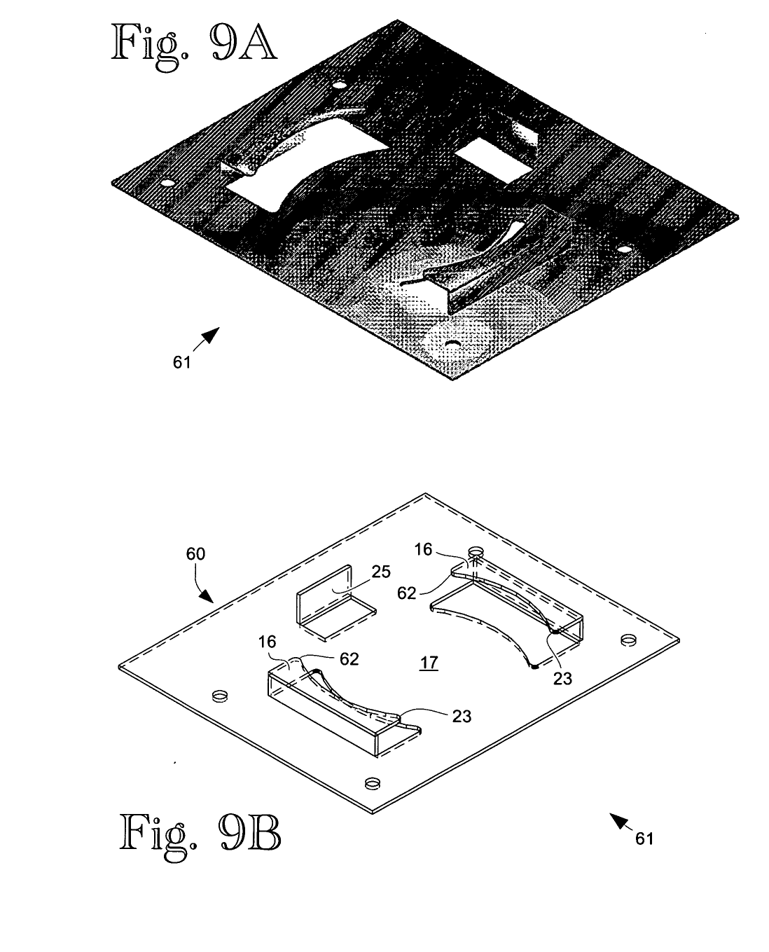

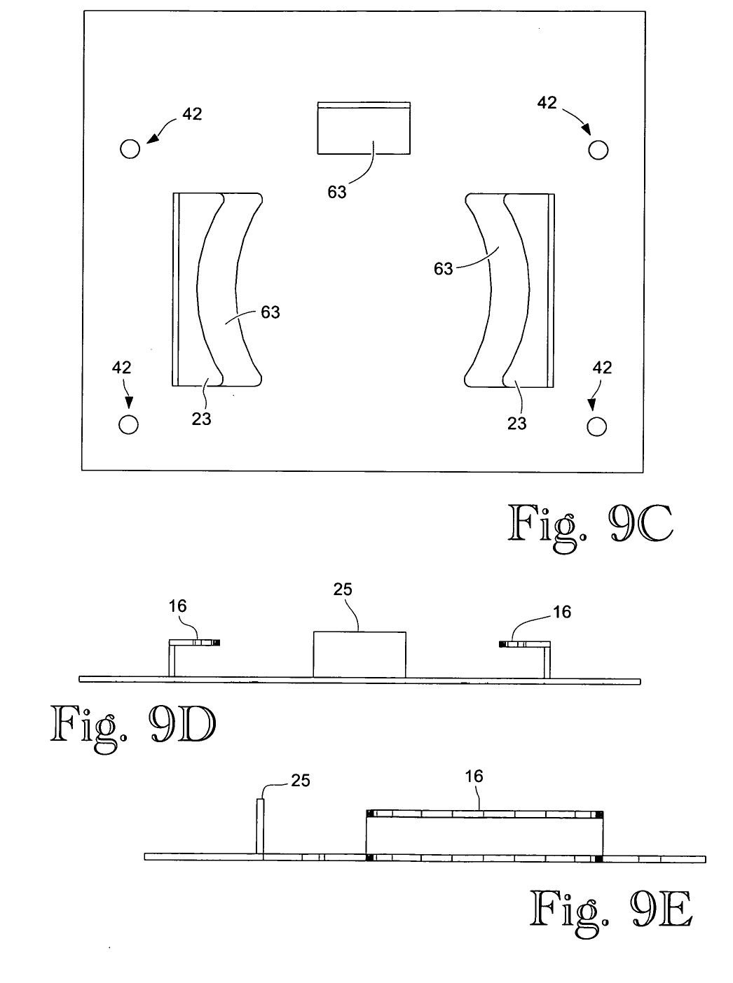

In a further example, a half receptacle might be stamped from sheet metal. That example 61 is depicted in perspective in FIG. 9A, in a perspective hidden-line drawing in FIG. 9B, from the bottom in FIG. 9C, from the front side in FIG. 9D, and from the side in FIG. 9E, a study of which will make aspects of this example apparent. A body 60 is formed from a piece of sheet metal, which might be die cut or otherwise separated from a larger sheet. Holes 42 may be stamped, drilled or otherwise fashioned in body 60 for the securement of the half receptacle 61 by fasteners, or other attachment features may be included as desired. Body 60 begins being substantially flat, and thereby forms an interface 17 to mate with a cup rim. Shoulders 16 are cut and bent out from body 16, and a stop 25 may also be cut and bent if desired. As in the examples above, restriction shoulder portions 23 restrict an exiting movement of a cup.

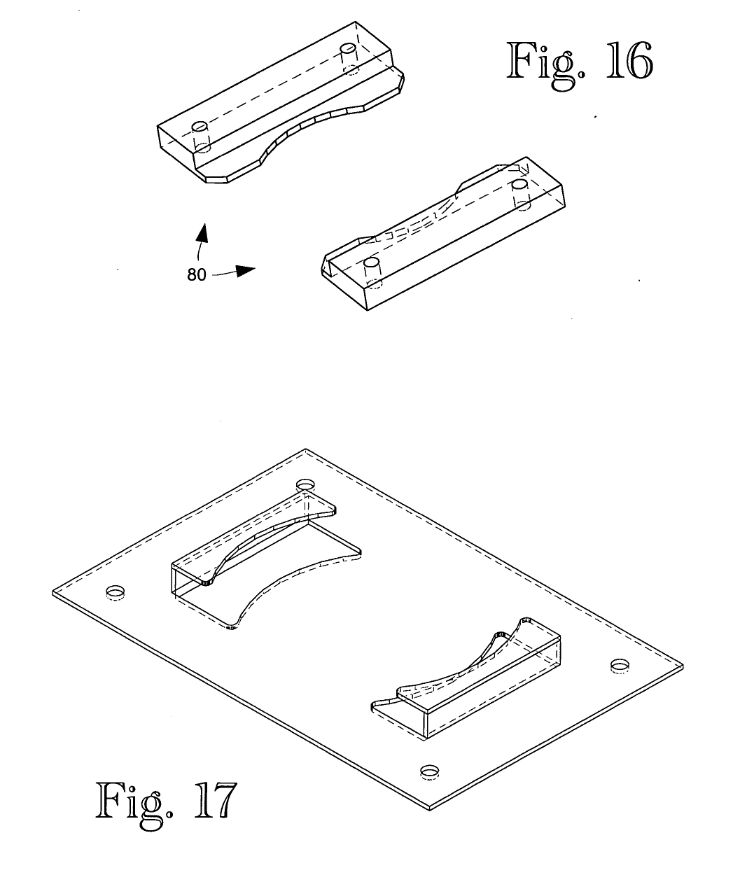

Holes 63 left by the formation of shoulders 16 or stop 25 do not impair the function of movement or securement of a cup, as in this example interface 17 maintains sufficient contact areas. Holes 63, depending on the circumstances and the articles used, may prevent complete containment the contents of the cup, especially where the receptacle is subject to jostling or vibrations. In that case, it may be desired to fasten a receptacle such as that shown in FIGS. 9A-9E or FIG. 17 to a regular flat surface having no substantial holes, thereby completing the containment of the cup in combination with the receptacle.

Stop 25 is not required, if shoulders 16 incorporate rearward restrictions 62 restricting the insertion-directed movement of a cup, forming an effective stop. If desired, the separation between rearward restrictions 62 may be closer together than restrictions 23 to make travel more difficult in the direction of insertion if restrictions 62 are contacted by the cup. Rearward restrictions might even completely join to form a single or composite stop, in this example contacting the cup sidewall rather than the rim. Alternatively, restrictions 62 may be positioned at about the same distance as restrictions 23, thereby making a two sided receiver without a stop, accessible from the front or the back, as depicted in FIG. 17.

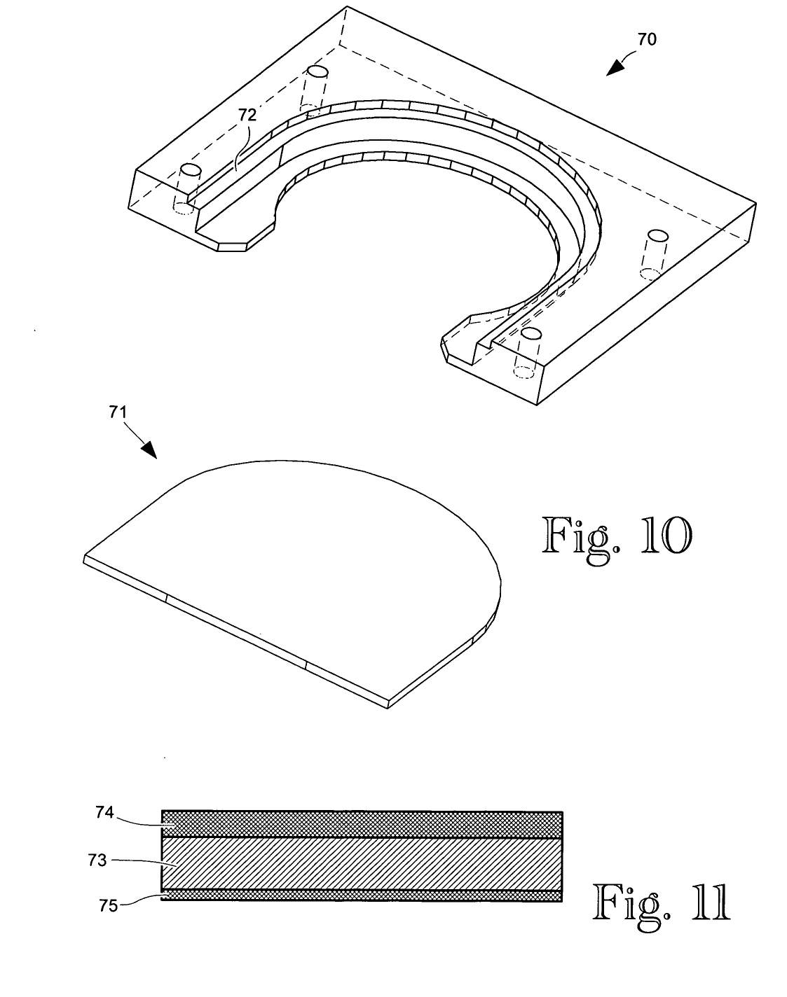

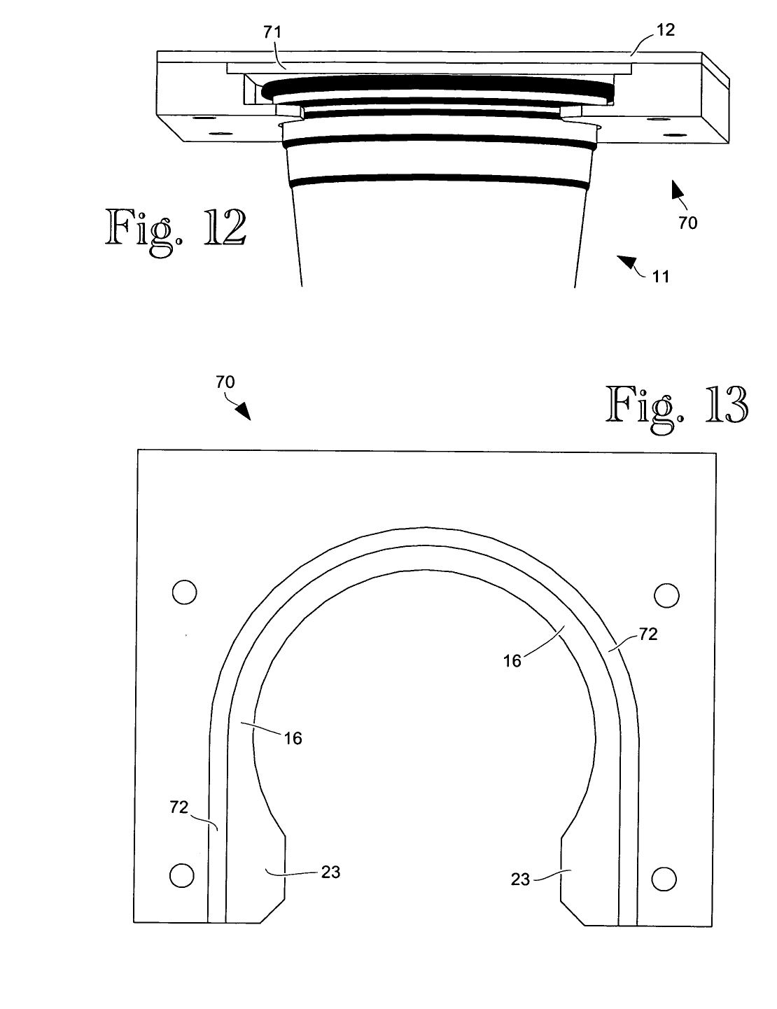

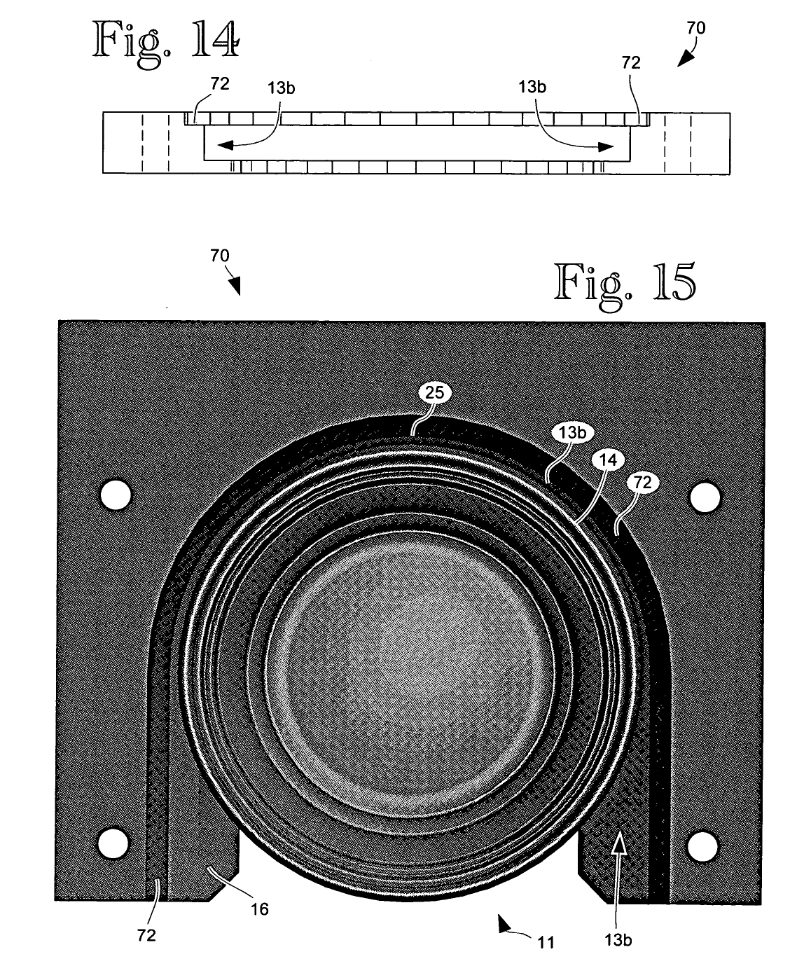

A receptacle may also be formed to receive or incorporate a seal for an inserted cup. One such exemplary half receptacle 70 is shown in perspective in FIG. 10, from the top in FIG. 13 and from the front in FIG. 14, which is an adaptation of the half receptacle shown in FIGS. 6A-C. Referring now to FIG. 10, receptacle 70 incorporates a seat 72 adapted to receive a seal 71. Looking now at FIG. 12, the rim of cup 11 inserted into receptacle 70 interfaces now not with substrate 12, but rather with the seal 71. Substrate 12, in this example, acts as a backer to seal 71, and may provide support for seal 71 against pressure applied from cup 11. Thus substrate 12 might not be needed if seal 71 is sufficiently stiff and if seal 71 is otherwise held in position to half receptacle 70.

Seal 71, in this example, is compressible. Thus seal 71 applies sealing pressure against the rim of cup 11. A compressible seal might be made from many materials, including polyethylene or polyurethane cellular foams, polystyrene, or even felt. A compressible layer might be laminated or joined to a stiff backing thereby reducing wrinkling or tearing of the material in the receptacle and perhaps easing the insertion and removal of the seal into and from the receptacle. A seal may also incorporate a smooth surface for sliding against a cup rim and/or receptacle interior.

Now turning to FIG. 12, an exemplary seal construction includes an intermediate compressible layer 73 adhered to a backer 74. Layer 73 is formed from a compressible and resilient open-celled foam. In this example backer 74 is made from cardboard, although any stiff material could be used. A cup interfacing layer 75 provides a buffer between the foam of layer 73 and a cup rim, protecting against damage, and may also be made smooth. Layer 75 may also be made impermeable to seal in liquids or gasses inside the cup. Layer 75 might be a lamination of a plastic film, or it might be made by coating layer 73 with a curable compound such as a urethane or latex paint.

If desired, a seal may be pre-compressed at the contact points on seat 72, making the seal easier to slip in and out of a receptacle. This could be done with a foam through a pressing operation, with the application of heat, or the foam layer could be molded in a shape with reduced thickness at the seat contact. Seals of the construction of FIG. 11 could be made by laminating larger sheets of foam to a cardboard backer, for example by adhesives. The lamination could then be die-cut and pressed in a single operation, creating perforations in the backer and at the same time pre-compressing the foam layer. An interfacing layer could either be coated after pressing, or could be laminated before pressing, as desired. This operation could be made particularly efficiently by utilizing large rolls of material, and is highly susceptible to machine production.

A compressible seal may provide for a reduced interface gap at the rim of a cup in a receptacle. This might be desirable for storing certain volatile or atmospheric-reacting materials, for example paints, silicones or materials containing water. However, a seal need not be compressible for all uses, particularly those where it is merely desired to contain fine non-volatile materials or where it is desired to prevent contamination of the receptacle. In such a case, a seal might be made from a compressible or non-compressible material, for example cardboard, or even a solid block of material.

If a compressible seal is to be used, it may be desirable to separate a seal seat 72 and a cup rim, thereby providing for increased sealing pressure at the cup rim. The exemplary half receptacle 10 is designed to provide one type of separation. This is best viewed in FIG. 14, which shows half receptacle 70 from the top including an inserted cup, but omitting the seal and substrate. Referring back to the first receptacle in FIG. 5B, that channel 13 provided a snug fit for cup 11. This receptacle 70 incorporates a widened channel 13b, leaving a gap between cup rim 14 and rear wall 25 and between the edge of seat 72. At seat 72, a seal will not have freedom to move in the direction of the cup, and therefore a rim extending too close might not be effectively sealed. By leaving the gap, the cup rim 14 contacts the seal at a point where it is free to expand, thereby providing sealing pressure against the rim. Rather than providing a gap, a receptacle might also be configured to seat cup rim 14 slightly higher than seat 72, although that may increase resistance to movement of the cup in and out of the receptacle.

Recalling the example of FIG. 17, a stamped half-receptacle may be created providing insertion access to a cup from both the front and the back. A final example, shown in FIG. 16, includes two side portions 80, fastenable to a substrate. This half-receptacle might be made to accommodate several sizes of cups, as the distance between the side portions can be varied. Thus to set up this half receptacle for use with a particular cup, one would place a cup on a substrate at the location of securement, abut the two side portions alongside the cup in opposite securement positions, and fasten the side portions to the substrate in those positions. If desired, the shoulder portions may take a “V” shape rather than a rounded shape to increase the usable range of cup sizes.

Reflecting on the examples shown and described, a cup receptacle may find utility in many trades, hobbies or circumstances. An auto mechanic or a do-it-yourself mechanic might utilize receptacles holding cups that may be discarded without significant expense. Thus even though cups may have become contaminated by grease, oil, dust, dirt or other contaminants from parts placed therein, the cost of replacing a cup may be so low that a user may prefer to replace a cup rather than clean it. If desired, the sides of the cups can be labeled, providing for identification of the contents. Such writing could be done before or after articles are placed in the cup, or written on after these have been inserted to a receptacle—as a receptacle could securely hold the cup against the pressure of a writing instrument. Clear cups might be used providing an easy viewing of any contents. A receptacle can be mounted to secure a cup not only at the level of a table, but also at eye-level for easy viewing or another level for increased organizational options. A receptacle as shown and described secures cups in both horizontal and vertical directions, and provides security against spillage and infiltration of unwanted material or debris.

Many other trades might find advantages in the use of cup receptacles. For example, a cake or pastry decorator might store candies of various kinds, and additionally frostings and other pasty materials. As a receptacle can provide a closure for a cup, drying of the contents is reduced while the cup is stored in a receptacle. Should frosting dry out or no longer be needed, it may be discarded in the cup eliminating a clean up step while at the same time providing for instantaneous access to many items stored to a receptacle array. Similarly, a gourmet cook might use a receptacle array for storing spices, placed at a convenient location in the kitchen for adding a pinch of this and a dash of that. He might also store pre-measured quantities of ingredients available for addition to a dish at just the right moment.

A gardener, agriculturalist or naturalist might utilize a receptacle array in a survey activity. Should she need to collect a soil or biological sample, she merely retrieves a fresh cup, places the sample inside and secures it in the array. She might label the cup with the source of the sample by the location of collection, a description of the contents, or other information with a marker. The array may be carried back to a laboratory in a frame or other carrier, and the samples retrieved and identified or analyzed as appropriate. On the other hand, an array might store transplants, for example saplings for an orchard or forest, to be carried to a planting site.

A cup and receptacle is good for storing small articles, but could also be used to store sandy, powdery, aggregate, slurry-like or pasty materials. Dry chemicals might also be stored in this fashion. For example, dyes or swimming-pool algicides might be stored in cups and kept at a convenient place near the location of use. Vitamins or medications in powdered form for livestock might be stored in cups, labeled per time of application, thereby providing a system to provide the correct compositions and quantities at the appropriate times.

A restaurant might use an array to store pre-measured quantities of detergents, soaps, bleaches or other cleaners, reducing the chance of an errant application of a careless employee. A woodworker could store nails, screws, small saw blades, drill bits, router bits and other hardware in a common receptacle array mounted to a wall over a counter. A jeweler could store collections of semi-precious stones, or alloy pellets in a ready-to-use state. Similarly, a dental technician might utilize a receptacle array in storing various composites, abrasives, metals, mold-shaping tools and other materials in making crowns and other dental appliances. These examples are but a few of the many applications to which the receptacles disclosed herein might be used, and in no way should these examples be read to limit any inventions described or claimed herein.

While the present systems, products and methods have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed is:

1. A receptacle for securing a flexible cup including a sidewall and a rim, said receptacle including an entrance through which the flexible cup may be inserted into a secured position, comprising:
a substrate;
an interface configured to mate with the rim of the cup;
a shoulder configured to secure the cup from separation from said interface;
a channel located between said interface and said shoulder, said channel configured to accept the rim of the cup;
a rear wall, stop or effective stop restricting insertion of a cup beyond a secured position;
restriction shoulder portions disposed at the entrance of said receptacle, said restriction shoulder portions positioned at a distance smaller than that of the width of the cup at the area of shoulder engagement, between which said restriction shoulder portions is a space through which the cup may pass only by deformation;
wherein said receptacle in combination with an inserted cup forms a closure.

2. A receptacle according to claim 1, wherein said shoulder restricts motion parallel to said interface.

3. A receptacle according to claim 1, wherein said shoulder is configured to substantially encircle the cup.

4. A receptacle according to claim 1, wherein said channel accepts a portion of the sidewall of the cup.

5. A receptacle according to claim 1, wherein said restriction shoulder portions are tapered or rounded at the entrance of said receptacle.

6. A receptacle storage frame on which is mounted a plurality of receptacles according to claim 1.

7. A storage containment device comprising a receptacle according to claim 1 and a thin-walled disposable cup adapted to be secured in the receptacle.

8. A receptacle according to claim 1, further comprising a seat configured to receive a seal disposed between the rim of the cup and said substrate.

9. A receptacle according to claim 1, further comprising:
a seal adapted to create a seal at the rim of the cup, wherein said interface is located to said seal; and
a seat configured to receive said seal, said seat configured to dispose said seal between the rim of the cup and said substrate.

10. A receptacle and seal according to claim 9, wherein said seal is compressible, elastic or self-adjusting.

11. A receptacle according to claim 1, wherein said shoulder is configured to engage a step formed in the cup.

12. A half receptacle attachable to a substrate including a substantially flat interface configured to mate with the rim of a flexible cup, comprising:
a body securable to the substrate in an assembled configuration;
a shoulder configured to secure the cup from separation from the interface when said body is in the assembled configuration;
a channel located between the location of the interface and said shoulder in the assembled configuration, said channel configured to accept the rim of the cup;
a rear wall, stop or effective stop restricting insertion of a cup beyond a secured position;
restriction shoulder portions disposed at the entrance of said receptacle, said restriction shoulder portions positioned at a distance smaller than that of the width of the cup at the area of shoulder engagement, between which said restriction shoulder portions is a space through which the cup may pass only by deformation;
wherein said receptacle in combination with the substrate in the assembled configuration and an inserted cup forms a closure.

13. A half receptacle according to claim 12 formed in plastic through a molding process.

14. A half receptacle according to claim 12 formed of sheet metal, wherein said shoulder portions are formed in tabs cut and bent from the sheet metal body.

15. A half receptacle according to claim 12 mounted to a frame, wherein said frame provides a substrate to said half receptacle.

16. A receptacle for securing a flexible cup in a secured position, the cup including a sidewall and a rim, said receptacle defining an outward direction vectored substantially from the interior of the secured cup outward through the rim, an inward direction opposite to said outward direction, and transverse directions substantially perpendicular to the outward direction, said receptacle comprising:
a channel configured to receive the rim of the flexible cup;
an interface configured to mate with the rim of the cup thereby providing a limit to the secured positions of the cup in the outward direction relative to said receptacle;
a shoulder disposed opposite said interface relative to said channel, said shoulder configured to limit the secured position of the cup relative to said receptacle in the downward and transverse directions, wherein said shoulder is configured to contact an engagement area of the sidewall of the cup;
restriction shoulder portions disposed at the entrance of said receptacle, said restriction shoulder portions positioned at a distance smaller than that of the width of the cup at the engagement area, between which said restriction shoulder portions is a space through which the cup may pass only by deformation while remaining engaged in said channel; and
an effective stop restricting insertion of a cup beyond the secured position.

17. A receptacle according to claim 15, wherein said interface provides an effective seal against the rim of the cup.

18. A receptacle storage frame on which is mounted a plurality of receptacles according to claim 15.

19. A receptacle according to claim 15, further comprising a seat configured to receive a seal disposed between the rim of the cup and said substrate.

20. A receptacle according to claim 15, further comprising:
a seal adapted to create a seal at the rim of the cup, wherein said interface is located to said seal; and
a seat configured to receive said seal, said seat configured to dispose said seal between the rim of the cup and said substrate.
